(19) United States
(12) Patent Application Publication
(10) Pub. No.: US 2021/0229185 A1
(43) Pub. Date: Jul. 29, 2021

(54) METHOD FOR PRODUCING AT LEAST ONE DISC-SHAPED OR ANNULAR DISC-SHAPED COMPONENT

(71) Applicant: AFW Holding GmbH, Kirchham (AT)

(72) Inventor: Dominik WEINGÄRTNER, Pettenbach (AT)

(73) Assignee: AFW Holding GmbH, Kirchham (AT)

(21) Appl. No.: 17/059,345

(22) PCT Filed: May 28, 2019
(86) PCT No.: PCT/EP2019/063728

§ 371 Date: Nov. 27, 2020

(30) Foreign Application Priority Data
May 29, 2018 (EP) 18174898.9

(51) Int. Cl. B23B 1/00; B23B 5/28

(52) U.S. Cl. CPC B23B 1/00; B23B 2215/36; B23B 5/28

(57) ABSTRACT

A method for producing at least one disk-shaped or annular disk-shaped component, in particular a disk-shaped or annular disk-shaped wheel, that includes providing at least one blank which has a central axis and is to be machined mechanically, in particular by cutting; arranging or damping the blank in at least one clamping situation in which the central axis of the blank is at an angle to a vertical axis; mechanically machining the clamped blank, in particular by cutting, to produce the disk-shaped or annular disk-shaped component.

The invention relates to a method for producing at least one disk-shaped or annular disk-shaped component, in particular a disk-shaped or annular disk-shaped wheel.

Corresponding methods for producing disk-shaped or annular disk-shaped components, i.e., for example, disk-shaped or annular disk-shaped wheels, such as are used, for example, as wheels for rail vehicles or train wheels, are known per se from the prior art.

Corresponding methods typically include the provision of a blank, for example a disk-shaped or annular disk-shaped blank, to be mechanically machined, i.e. in particular by cutting, which is clamped in a clamping situation and is mechanically machined therein, i.e. in particular by cutting, in the formation of the component to be produced.

Heretofore, the blank in the clamping situation has typically been arranged or oriented in such a way that its axis of symmetry or central axis lies in a vertical axis or plane.

Various disadvantages can result from this clamping situation which, for example, consist of or result from the fact that machining-related removed materials, i.e. in particular chips, and/or cooling liquid, accumulate on the blank to be mechanically machined, and this can have a negative effect on the mechanical machining process.

The object of the invention is to specify a method, which represents an improvement, for producing at least one disk-shaped or annular disk-shaped component, in particular a disk-shaped or annular disk-shaped wheel.

The object is achieved by a method for producing at least one disk-shaped or annular disk-shaped component, in particular a disk-shaped or annular disk-shaped wheel according to claim 1. The dependent claims relate to possible embodiments of the measuring device.

The method described herein is used to produce at least one (substantially) disk-shaped or annular disk-shaped component, in particular a (substantially) disk-shaped or annular disk-shaped wheel or drive wheel. A disk-shaped or annular disk-shaped component to be produced according to the method, i.e. in particular a disk-shaped or annular disk-shaped wheel, can in particular be a wheel or drive wheel for rail vehicles, i.e. for example a train wheel, especially a train wheel for high-speed trains.

A component to be manufactured according to the method can under certain circumstances, i.e. depending on the specific intended field of use of the component, have a disk-like or annular disk-like geometry that deviates from a geometrically defined disk-shaped or annular disk-shaped geometry. Corresponding deviations can exist, for example, in a cross-sectional, for example, step-like contoured design of the outer circumference, as can be found, for example, in train wheels.

The procedure described herein includes the following steps:

In a first step of the method, at least one blank to be machined mechanically, i.e. in particular by cutting, is provided. The blank has a central axis. The central axis can be, for example an axis of symmetry of the blank. In this respect, the blank can have a rotationally symmetrical, i.e. in particular a disk-shaped or annular disk-shaped, geometry. An annular disk-shaped geometry differs from a disk-shaped geometry typically by a middle or central, possibly hole-like or -shaped recess, so that an annular disk-shaped blank, in contrast to a disk-shaped blank which only has an outer circumference, has both an outer circumference and an inner circumference, which defines a middle or central recess. A disk-shaped or annular disk-shaped blank typically has a disk plane. The disk plane is typically traversed by the central axis of the blank at a right angle; the central axis of the blank is therefore typically oriented perpendicular to the disk plane of the blank.

The blank or in any case the disk-shaped or annular disk-shaped component to be produced according to the method can have sections having different cross-sectional geometries or areas. For example, the blank or the component to be produced can have a different cross-sectional geometry in the region of the outer circumference than, viewed radially, regions further inside. For the manufacture of a wheel, in particular a train wheel, it applies that the outer circumference of the blank can later form a running surface of the component.

According to the method, a metallic blank, i.e. a blank made of a, for example, ferrous metallic material, is typically provided; accordingly, the disk-shaped or annular disk-shaped component according to the method is a metallic component, i.e. a component made of a ferrous, metallic material. The blank is in particular a semi-finished product or pre-product. Specifically, the blank can be a metallic cast or forged part, i.e. a blank made from a metallic cast or forged alloy.

A correspondingly provided blank to be mechanically machined is used in a second step of the method following the first step in at least one clamping situation, i.e. in particular a clamping position or clamping orientation of the blank (hereinafter only the term “clamping situation” is used, which includes a specific clamping position or clamping orientation of the blank). Each clamping situation of the blank is correlated with at least one specific machining situation of the blank, i.e. in particular a machining position or machining orientation of the blank (hereinafter only the term “clamping situation” is used, which includes a specific clamping position or clamping orientation of the blank).

According to the method, the blank is clamped in at least one clamping situation in which the central axis of the blank is at an angle to a vertical axis or plane; the central axis of the blank is therefore (apart from any point of intersection) outside a vertical axis or plane. According to the method, the blank to be mechanically machined is generally arranged in the clamping situation in such a way that the central axis of the blank is at an angle to a vertical axis or plane, i.e. in particular not parallel to a vertical axis or plane. For a disk-shaped or annular disk-shaped blank, it applies that the disk plane of the blank in the clamping situation is or will be oriented at an angle or tilted with respect to a horizontal axis or plane; As is shown below, the disk plane of the blank in the clamping situation can in particular be or become oriented parallel to a vertical axis or plane.

From the angularly inclined or tilted arrangement or orientation of the blank relative to the vertical axis or plane—this can, for example be defined by a vertical machine axis of a machining center used to carry out the method—there are a number of advantages for the mechanical machining of the blank and thus for the production of the disk-shaped or annular disk-shaped component to be produced according to the method. These advantages are in particular that it becomes more difficult or not possible at all for machining-related removed materials, i.e. in particular chips, and/or cooling liquid, to accumulate on the blank to be machined, depending on the specific orientation of the blank relative to the vertical axis. This also leads to the fact that the cooling effect and thus the efficiency of the cooling of the blank during its mechanical machining can be (considerably) improved, as it only becomes more difficult or is not at all possible for the typically used cooling liquid to accumulate on the blank, i.e. a disk-shaped or annular disk-shaped blank, in particular a surface of the blank that is parallel to a disk plane, and heat up. The mechanical machining process of the blank can also be better (optically) observed; so that there are also advantages with regard to a process monitoring to be implemented or that is implemented. The aforementioned advantages exist in particular compared to a known clamping of the blank in a clamping situation in which the central axis of the blank lies in a vertical axis or plane.

The blank can be clamped in the described clamping situation via a clamping device comprising one or more clamping elements, i.e. for example one or more clamping jaws, i.e. for example a chuck of a machining center used to carry out the method. The or a clamping device used according to the method is therefore configured to clamp the blank in the described clamping situation. A corresponding clamping device can also be configured to implement a plurality of different clamping situations, in particular a plurality of different clamping situations in which the central axis of the blank is in each case at an angle to a vertical axis or plane. A corresponding clamping device can be movably mounted in at least a degree of freedom of movement—this can be a translational degree of freedom along at least one translation axis and/or a rotational degree of freedom about at least one axis of rotation. A corresponding translation or rotation axis can, for example, be defined by a machining or machine axis of a machining center used to carry out the method.

In a third step of the method following the second step, the mechanical machining of the blank clamped in the clamping situation is performed, in which the central axis of the blank is at an angle to the vertical axis or plane, to produce the disk-shaped or annular disk-shaped component. The mechanical machining of the blank is based in particular on data relating to the final geometry of the component to be produced, so that the component is produced close to its final shape or with an exact shape. The mechanical machining of the blank typically includes at least one mechanical machining step involving cutting or chipping. The mechanical machining of the blank can therefore be accomplished, for example, by drilling and/or turning and/or milling or include drilling and/or turning and/or milling.

The mechanical machining of the blank can be carried out using at least one mechanical machining device comprising at least one mechanical machining tool, i.e. in particular a drilling and/or turning and/or milling tool, i.e. in particular a drilling and/or turning and/or milling unit of a machining center used to implement the method. Depending on the specific configuration, the mechanical machining device can be movably mounted in at least a degree of freedom of movement—this can be a translational degree of freedom of movement along at least one translation axis and/or a rotational degree of freedom of movement about at least one axis of rotation—relative to the blank clamped in the clamping situation.

Overall, there is an improved method for producing a disk-shaped or annular disk-shaped component.

According to the method, the blank can be clamped in such a way that the central axis of the blank is oriented at an angle between 1 and 179°, in particular between 15 and 175°, preferably at an angle between 30 and 150°, relative to the vertical axis or plane. The angle between the blank clamped in the clamping situation and the vertical axis or plane can therefore be between 1 and 179°, in particular between 15 and 175°, preferably between 30 and 150°. The angle between the blank clamped in the clamping situation and the vertical axis or plane is particularly preferably between 80 and 100°, in particular between 85 and 95°.

According to a specific embodiment of the method, the blank can be clamped such that its central axis is oriented at an angle of 90° relative to the vertical axis or plane. The central axis of the blank can thus be or become oriented horizontally in the clamping situation. In the clamping situation, the central axis of the blank can thus be oriented coaxially or concentrically with a machining axis of a machining center used to carry out the method. The disk plane of a disk-shaped or annular disk-shaped blank can thus be or become oriented vertically in the clamping situation.

The aforementioned angles or angular ranges can be understood to be clockwise or counterclockwise.

The blank can be clamped in a clamping situation in which a mechanical machining at least in sections, in particular a complete mechanical machining, of a surface of the blank lying parallel to a central plane of the blank and a mechanical machining at least in sections, in particular a complete mechanical machining, of the outer circumference of the blank is performed. The clamping situation is typically characterized in that at least one clamping element, in particular at least one clamping jaw, engages at least one clamping device on a portion of the blank to form a clamping of the blank. In this case, the blank in the clamping situation is typically clamped in such a way that the central axis of the blank is at an angle, i.e. in particular at a right angle, to the vertical axis or plane. The clamping situation thus typically correlates with a certain machining situation of the blank.

In the clamping situation, as mentioned, a mechanical machining can be performed at least in sections, in particular a complete mechanical machining, of a surface of the blank lying parallel to a central plane, i.e. for an (annular) disk-shaped blank parallel to a disk plane, i.e. for example an upper or lower side of the blank. Such mechanical machining can mean a mechanical machining of the blank that is performed axially with respect to an (annular) disk-shaped geometry of the blank, so that an (annular) disk-shaped blank, in particular by turning, e.g. is provided with axially oriented through holes or blind holes, for example for forming or machining a hub of the component to be manufactured. Alternatively or additionally, such a mechanical machining can mean a mechanical machining of the blank that is performed radially with respect to an (annular) disk-shaped geometry of the blank, so that an (annular) disk-shaped blank for example is provided with radially extending, in particular annular, recesses. With a corresponding mechanical machining of the inside diameter or in the region of the inside diameter of the blank, in some cases a formation of a middle or central recess of the blank can also be understood as being made, for example, by drilling and/or turning and/or milling, so that a disk-shaped blank is converted into an annular disk-shaped blank. Correspondingly, a hub of the component to be produced can also be formed in this way. A targeted change in the cross-sectional geometry of the blank is possible.

Furthermore, in the (same) clamping situation, an at least sectional, in particular complete, mechanical machining of the outer circumference of the blank, i.e. for an (annular) disk-shaped blank of a lateral surface of the blank forming the outer circumference, can be performed. Such a machining can mean machining the blank axially (with respect to the central axis of the blank) with respect to an (annular) disk-shaped geometry of the blank, so that an (annular) disk-shaped blank, in particular by turning and/or milling, e.g. is provided with a certain outer circumferential contour, in particular one forming the running surfaces of a wheel to be manufactured. Mechanical machining of the blank clamped in the clamping situation can therefore (also) be used to machine the outer contour or the lateral surface of the disk-shaped or annular disk-shaped component to be produced, i.e. in particular of the region of the running surfaces of a wheel to be produced. Here, too, a targeted change in the cross-sectional geometry of the blank is possible.

The blank can be clamped in the clamping situation for example via clamping elements engaging, in particular axially, a section of the inner diameter of the blank, in some cases shoulder-like, protruding, or recessed, for example, in the manner of a borehole. For a disk-shaped or annular disk-shaped blank, it applies accordingly that it can be clamped via clamping elements engaging a surface of the blank lying parallel to a disk plane, i.e., for example, an upper or lower side of the blank. Clamping jaws engaging for example on the inside diameter or on a corresponding surface are contemplated as clamping elements used to clamp the blank. In particular, a plurality of clamping jaws arranged circumferentially distributed, preferably evenly, can be used. The clamping jaws can be arranged in such a way that the blank can be centered.

In the clamping situation in which both a mechanical machining of a surface of the blank lying parallel to a central plane, i.e. for an (annular) disk-shaped blank parallel to a disk plane, i.e. for example an upper or lower side of the blank, and a mechanical machining of the outer circumference of the blank is performed, non-machinable or machinable sections of the blank can be mechanically machined in one of the same clamping situations. For this purpose, a rotational or turning movement of the blank mechanically machined in sections may be necessary. The blank mechanically machined in sections can be moved, rotated or turned out of the clamping situation after mechanical machining in the clamping situation—this is in particular a 180° rotation or turn—and moved back into the (same) clamping situation and clamped again in order to then machine the remaining sections that have not yet been mechanically machined. The blank can then be clamped on opposite section of the blank; in the renewed clamping of the blank in the clamping situation in comparison to the first or previous clamping, the clamping elements engage opposite section of the blank in the clamping situation.

For this purpose, a suitable handling of the blank mechanically machined in sections may be required, which for example can be implemented via a handling device, i.e. in particular a robot device.

The blank can also be clamped in a plurality of clamping situations that are different, in particular with respect to the particular spatial orientation of the blank, i.e. clamping situations that are in particular locationally or spatially arranged or spaced differently, i.e. at least in a first clamping situation and in a second clamping situation. Each clamping situation is typically characterized in that at least one clamping element, in particular at least one clamping jaw, engages at least one clamping device on a section of the blank to form a clamping of the blank. In the particular clamping situations, the blank is typically clamped in such a way that the central axis of the blank is at an angle, i.e. in particular at a right angle, to the vertical axis or plane. However, it is also conceivable that the central axis of the blank in at least one clamping situation is not at an angle to a vertical axis or plane.

Regardless of the specific clamping and the resulting spatial orientation of the blank relative to the vertical axis or plane, in every clamping situation, as mentioned, there is typically a mechanical machining of a specific, in particular exposed, and thus mechanically machinable section of the blank. Each clamping situation thus typically correlates with a certain machining situation of the blank.

The blank can be clamped in a first exemplary clamping situation, in which a mechanical machining is performed at least in sections, in particular a complete mechanical machining, a surface of the blank lying parallel to a central plane, i.e. for an (annular) disk-shaped blank parallel to a disk plane, i.e. for example an upper or lower side of the blank. Such mechanical machining can mean a mechanical machining of the blank that is performed axially with respect to an (annular) disk-shaped geometry of the blank, so that an (annular) disk-shaped blank, in particular by turning, e.g. is provided with axially oriented through holes or blind holes, for example for forming or machining a hub of the component to be manufactured. Alternatively or additionally, such a mechanical machining can mean a mechanical machining of the blank that is performed radially with respect to an (annular) disk-shaped geometry of the blank, so that an (annular) disk-shaped blank for example is provided with radially extending, in particular annular, recesses. With a corresponding mechanical machining of the inside diameter or in the region of the inside diameter of the blank, in some cases a formation of a middle or central recess of the blank can also be understood as being made, for example, by drilling and/or turning and/or milling, so that a disk-shaped blank is converted into an annular disk-shaped blank. Correspondingly, a hub of the component to be produced can also be formed in this way. In all cases, it is possible to change the cross-sectional geometry of the blank in a targeted manner.

The blank can be clamped in a second exemplary clamping situation, in which a mechanical machining at least in sections, in particular a complete mechanical machining, is performed on the outer circumference of the blank, i.e. for an (annular) disk-shaped blank of a lateral surface of the blank forming the outer circumference. Such a machining can mean machining the blank axially (with respect to the central axis of the blank) with respect to an (annular) disk-shaped geometry of the blank, so that an (annular) disk-shaped blank, in particular by turning and/or milling, e.g. is provided with a certain outer circumferential contour, in particular one forming the running surfaces of a wheel to be manufactured. Mechanical machining of the blank clamped in the second clamping situation can therefore be used to machine the outer contour or the lateral surface of the disk-shaped or annular disk-shaped component to be produced, i.e. in particular the region of the running surfaces of a wheel to be produced. Here, too, a specific change in the cross-sectional geometry of the blank is possible in all cases.

In the first example of a clamping situation, the blank can be clamped via clamping elements engaging, in particular axially, a section of the inner diameter of the blank, in some cases shoulder-like, protruding, or recessed, for example, in the manner of a borehole. For a disk-shaped or annular disk-shaped blank, it applies accordingly that this can be clamped in the first clamping situation via clamping elements engaging a surface of the blank lying parallel to a disk plane, i.e. for example an upper or lower side of the blank. Clamping jaws engaging, for example, on the inside diameter or on a corresponding surface are contemplated as clamping elements used in the first clamping situation to clamp the blank. In particular, a plurality of clamping jaws arranged circumferentially distributed, preferably evenly, can be used. The clamping jaws can be arranged in such a way that the blank can be centered in the first clamping situation. In principle, what is described in this paragraph can also apply to the second exemplary clamping situation explained below.

In the second exemplary clamping situation, the blank can be clamped by means of clamping elements engaging the outer circumference of the blank. For a disk-shaped or annular disk-shaped blank, it applies accordingly that it can be clamped in the second clamping situation by clamping elements engaging a lateral surface that forms the outer circumference. Clamping jaws engaging, for example, the outer circumference or a lateral surface forming the outer circumference are contemplated as clamping elements used in the second clamping situation to clamp the blank. In particular, a plurality of clamping jaws arranged distributed, preferably evenly, about the outer circumference can be used. The clamping jaws can be arranged in such a way that the blank can be centered in the second clamping situation. In principle, what is described in this paragraph can also apply to the first exemplary clamping situation.

A blank can therefore be clamped and mechanically machined in a plurality of different clamping situations, in some cases arranged opposite one another. Each clamping situation is correlated with a specific machining situation, i.e. in particular a specific mechanical machining step. As mentioned, the sections of the clamped blank that are exposed in each clamping or machining situation can be mechanically machined.

Accordingly, the blank from a first clamping situation, for example, in which the central axis of the blank to be mechanically machined is at an angle to the vertical axis or plane, is transferred to at least one further clamping situation in which the central axis of the blank to be mechanically machined is at an angle to a vertical axis or plane. The particular clamping situations can be opposite one another. This opens up the possibility, described in more detail below, of providing a plurality of blanks and of mechanically machining them at least in part simultaneously. According to the method, a plurality of blanks to be machined mechanically and having a central axis can be provided and be machined to form the particular disk-shaped or annular disk-shaped components to be manufactured. The mechanical machining of the particular components can, as will be seen below, be performed at least in part simultaneously; this results in positive aspects for the efficiency and productivity of the method.

It is for example possible that a first blank to be mechanically machined is initially clamped in a first clamping situation, in which the central axis of the first blank is at an angle to the vertical axis or plane, and in a first mechanical machining step is mechanically machined at least in sections in the first clamping situation. After completion of the first mechanical machining step, the first blank, which has already been machined in sections, can be transferred into a second clamping situation (different from the first clamping situation) in which the central axis of the first blank is again at an angle to the vertical axis or plane, clamped therein and in a second mechanical machining step can be transferred mechanically machined at least in sections. During or after clamping of the first blank in the second clamping situation, a further blank to be mechanically machined can be clamped in the first clamping situation, in which the central axis of the further blank is at an angle to the vertical axis or plane, and mechanically machined in a first mechanical machining step at least in sections in the first clamping situation. After completion of the first mechanical machining step, the further blank, which has already been machined in sections, can be transferred into the or a second clamping situation, in which the central axis of the further blank is again at an angle to the vertical axis or plane, clamped therein and in a second mechanical machining step is mechanically machined at least in sections. If the second clamping situation is the second clamping situation in which the first blank is subjected to the second mechanical machining step, this typically is performed only when the first blank has left the second clamping situation, i.e. the second mechanical machining step of the first blank is completed in the second clamping situation. Mechanical machining of a plurality of blanks can therefore be performed in succession in a plurality of clamping situations, i.e. machining of a plurality of blanks in a plurality of clamping situations one after the other. The second mechanical machining step of the first blank can be performed at least in part at the same time as the first mechanical machining step of the further blank (and vice versa). The principle can be extended to more than two clamping situations and correspondingly more than two mechanical machining steps correlated therewith.

Furthermore, it is possible that a first blank to be mechanically machined is initially clamped in a first clamping situation, in which the central axis of the first blank is at an angle to the vertical axis or plane, and then is mechanically machined at least in sections in a first mechanical machining step in the first clamping situation. After completion of the first mechanical machining step, the blank, which has already been mechanically machined in sections, can be transferred to a second clamping situation, in which the central axis of the first blank is again at an angle to the vertical axis or plane, clamped therein and can be mechanically machined at least in sections in a second mechanical machining step. A further blank to be mechanically machined can initially be clamped in the second clamping situation, in which the central axis of the second blank is at an angle to the vertical axis or plane, and is mechanically machined at least in sections in a first mechanical machining step in the second clamping situation. After completion of the first mechanical machining step of the first blank in the first clamping situation and after completion of the first mechanical machining step of the further blank in the second clamping situation, the first blank can be transferred into the second clamping situation, in which the central axis of the first blank is at an angle to the vertical axis or plane, is clamped therein and is mechanically machined at least in sections in a second mechanical machining step, and, after completion of the first mechanical machining step of the further blank in the second clamping situation and the first mechanical machining step of the first blank in the first clamping situation, the further blank transferred into the first clamping situation, in which the central axis of the further blank is at an angle to the vertical axis or plane, is clamped therein and in a second mechanical machining step is mechanically machined at least in sections. A simultaneous mechanical machining of the blanks can therefore be performed in the particular clamping situations. The blanks machined at least in sections in the respective first machining steps can then swap their respective first clamping situations and, after clamping in respective second clamping situations, be subjected to respective second mechanical machining steps. The first mechanical machining step of the first blank can therefore be performed at the same time as the first mechanical machining step of the further blank. The second mechanical machining step of the first blank can therefore also be performed at the same time as the second mechanical machining step of the further blank. The principle can be extended to more than two clamping situations and correspondingly more than two mechanical machining steps correlated therewith.

In all cases, at least one machining device can be assigned to each clamping situation. The machining device assigned to the particular clamping situation—as mentioned, this can be, for example, a machining device for drilling and/or turning and/or milling—is configured to perform a mechanical machining of the clamped blank to be carried out in the particular clamping situation or the machining situation correlated therewith. The machining device assigned to the particular clamping situation can for this purpose be movably mounted with at least a degree of freedom of movement—here, as mentioned, it can be a translational degree of freedom of movement along at least one translation axis and/or a rotational degree of freedom of movement about at least one axis of rotation—relative to the blank clamped in the particular clamping situation. Alternatively or additionally, however, it is also conceivable in principle that the blank clamped in the respective clamping situation is movably supported in at least a degree of freedom of movement, i.e. for example a degree of freedom of movement along a translation axis and/or about an axis of rotation, relative to the mechanical machining device assigned to the respective clamping situation; as mentioned above, a clamping device can also be movable in at least a degree of freedom of movement.

The transfer of a blank, in some cases already mechanically machined at least in sections, from a first clamping situation to a second or at least one further clamping situation (or vice versa) can be performed in a specific transfer position in which a transfer or handover of a blank from a first clamping situation to at least a further clamping situation (or vice versa) is possible. A blank to be transferred from the first clamping situation to a further clamping situation (or vice versa), in some cases already mechanically machined at least in sections, can therefore be moved into a corresponding transfer position—this can be arranged, for example, between the two clamping situations.

The transfer of a blank, in some cases already mechanically machined at least in sections, from a first clamping situation to a second or at least one further clamping situation (or vice versa) can be carried out using one or more handling elements, i.e., for example, one or more gripper elements, i.e., for example, a handling robot, a machining center used to carry out the method. The handling device or a handling device used according to the method is therefore configured to transfer a blank, which may have already been mechanically machined at least in sections, from a first clamping situation into at least a second or at least one further clamping situation (or vice versa). A corresponding handling device can be designed as a gripper device comprising at least one gripper element or can comprise at least one such gripper device. A gripper device can, for example, be designed as a (multi-axis) gripping robot.

As explained above, the method can be carried out in a machining center for mechanical, i.e. in particular cutting, machining of (metallic) workpieces.

In addition to the method, the invention therefore also relates to a machining center for the mechanical, in particular cutting, machining of a blank to be machined mechanically, in particular by cutting, for the production of a disk-shaped or annular disk-shaped component, in particular according to a method as described above. The machining center comprises at least one clamping device which is configured to clamp a mechanically machined blank in a clamping situation in which the central axis of the blank to be machined mechanically, in particular by cutting, is at an angle to a vertical plane, as well as at least one mechanical machining device comprising at least one mechanical machining tool, i.e., for example, a drilling and/or turning and/or milling tool, i.e., for example a drilling and/or turning and/or milling unit which is configured to mechanically machine, at least in sections, a blank that is clamped in the clamping situation.

Because the machining center is configured to manufacture at least one disk-shaped or annular disk-shaped component from a blank to be mechanically machined according to a method as described above and thus to carry out the method described above, all statements in connection with the method apply analogously to the machining center.

The vertical plane with respect to which the blank can be clamped or is clamped at an angle according to the method is typically oriented perpendicular to a (horizontal) machining or machine axis of the machining center.

The invention is explained in reference to embodiments in the drawings, in which:

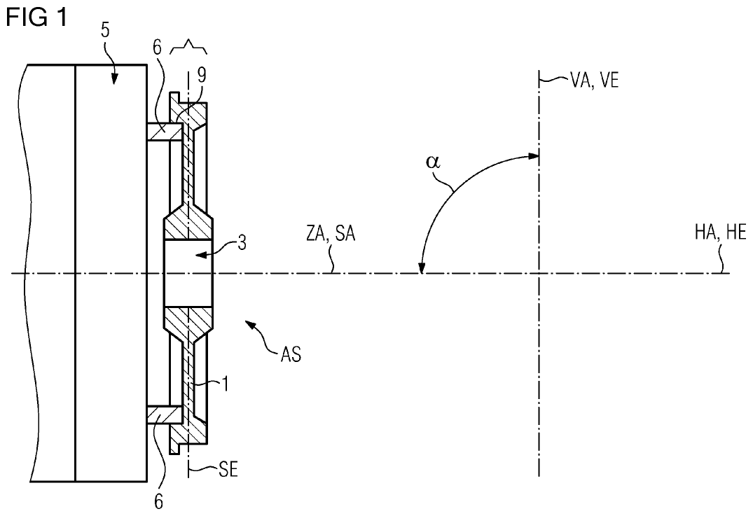

FIG. 1, 2 are each a schematic diagram of a blank clamped in a clamping situation in accordance with the method according to an embodiment; and

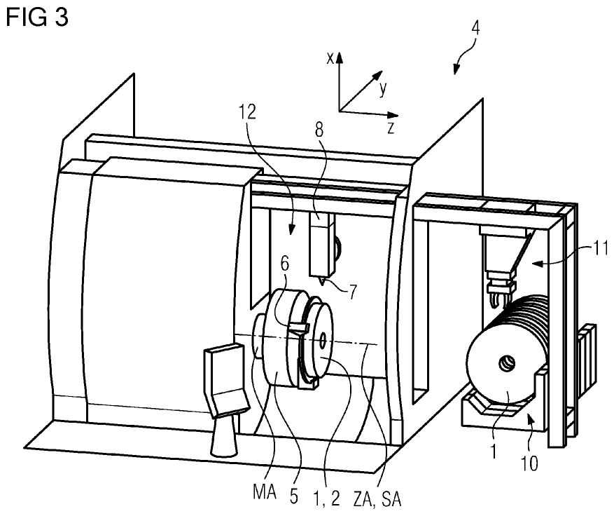

FIG. 3, 4 are each a schematic diagram of a machining center used to carry out the method according to an embodiment.

FIG. 1, 2 are each a schematic diagram of a blank 1 clamped in a clamping situation AS according to an embodiment. The clamping of the blank 1 in the clamping situations AS shown in FIG. 1, 2 is performed within the framework of implementing a method for producing a component 2 in the form of a disk-shaped or annular disk. The component 2 to be produced according to the method is, in particular, a drive wheel for rail vehicles, i.e. a train wheel, in particular a train wheel for high-speed trains.

The method described in connection with the embodiments shown in the figures comprises the following steps:

In a first step of the method, at least one blank 1 to be machined mechanically, i.e. by cutting, is provided. In the embodiments shown in the figures, the blank 1 has a rotationally symmetrical, annular disk-shaped geometry with a middle or central recess 3. The central axis of the blank 1 is labeled “ZA”; it can be seen that the central axis ZA of the blank 1 is identical to the axis of symmetry of the blank 1 labeled “SA.” The disk plane of the blank 1, which is oriented perpendicular to the central axis ZA and thus traversed by the central axis ZA of the blank 1 at a right angle, is denoted by “SE.” The following statements apply analogously to a (purely) disk-shaped blank 1, i.e. a blank 1 which does not have a middle or central recess 3.

According to the method, a metallic blank 1, i.e., for example, a cast or forged part, is typically provided; accordingly, the component 2 to be produced according to the method is a metallic component.

The blank 1 is clamped in a second step of the method following the first step in at least one clamping situation AS (see in particular FIG. 1, 2). It can be seen from the figure that the blank 1 is clamped in a clamping situation AS in which the central axis ZA of the blank 1 is at an angle to a vertical axis VA or plane VE (this or they can be defined, for example, by a vertical machine axis of a machining center 4 used to carry out the method) and thus (apart from a possible intersection) is outside a vertical axis VE or plane VE. According to the method, the blank 1 is arranged in the clamping situation AS so that the central axis ZA of the blank 1 is at an angle to the vertical axis VA or plane VE and thus in particular not parallel to the vertical axis VA or plane VE. In the clamping situation AS, the disk plane SE of the blank 1 is inclined at an angle or tilted with respect to a horizontal axis HA or plane HE (this or they can be defined e.g. by a horizontal machine axis of a machining center 4 used to carry out the method).

As can be seen, the blank 1 in the embodiments shown in the figures is clamped in such a way that the central axis ZA of the blank 1 is at an angle α between 1 and 179°, in particular between 15 and 175°, preferably at an angle α between 30 and 150°, namely specifically oriented at an angle of 90° relative to the vertical axis VA or plane VE. The central axis ZA of the blank 1 is correspondingly oriented horizontally in the clamping situation AS, the disk plane SE of the blank 1 correspondingly vertically. The central axis ZA of the blank 1 in the clamping situation AS is thus typically oriented coaxially or concentrically to a machining axis BA of a machining center 4 used to carry out the method (see FIG. 3, 4).

The described angularly inclined or tilted arrangement or orientation of the blank 1 relative to the vertical axis VA or plane VE results in a number of advantages for the mechanical machining of the blank 1 and thus for the production of the component 2 to be produced according to the method. These advantages are in particular that it becomes more difficult or not possible at all for machining-related removed materials, i.e. in particular chips, and/or cooling liquid, to accumulate on the blank 1 to be machined. This also results in it being more difficult or not at all possible to (substantially) improve the cooling effect and thus the efficiency of cooling of the blank 1 during its mechanical machining over that of the cooling liquid typically used on the blank 1; i.e. it can in particular collect on a surface of the blank 1 that is parallel to the disk plane SE of the blank 1 and heat up there. The mechanical machining process of the blank 1 can also be better (optically) observed; so that there are also advantages with regard to a process monitoring that is to be implemented or has been implemented.

The clamping of the blank 1 in the clamping situation AS is performed in the embodiments shown in the figures via at least one clamping device 5 comprising a plurality of clamping elements 6, i.e., for example, clamping jaws, i.e., for example, a chuck of a machining center 4 used to carry out the method. The clamping device 5 is therefore configured to clamp the blank 1 in the described clamping situation AS.

In a third step of the method following the second step, the mechanical machining of the blank 1 clamped in the clamping situation AS is performed in order to produce the component 2. The mechanical machining of the blank 1 is based, in particular, on data relating to the final geometry of the component 2 to be produced, so that the component 2 is produced close to the final contour or conforming exactly the final contour. The mechanical machining of the blank 1 comprises at least one mechanical machining step involving cutting or chipping. The mechanical machining of the blank 1 can therefore be performed, for example, by drilling and/or turning and/or milling or include drilling and/or turning and/or milling.

The mechanical machining of the blank 1 is performed via at least one mechanical machining device 8 comprising at least one mechanical machining tool 7, i.e. in particular a drilling and/or turning and/or milling tool, i.e. in particular a drilling and/or turning and/or milling unit of a machining center 4 used to carry out the method (see FIG. 3, 4). A corresponding mechanical machining device 8 can, depending on the specific configuration, be movably mounted in at least a degree of freedom of movement—this can be a translational degree of freedom of movement along at least one translation axis and/or a rotational degree of freedom of movement about at least one axis of rotation—relative to the blank 1 clamped in the clamping situation AS. Corresponding degrees of freedom of movement or translation or rotation axes are indicated in FIG. 3, 4 by the axes x, y and z.

FIG. 1, 2 show that the or a blank 1 can be clamped in a plurality of different clamping situations AS. Each clamping situation AS is characterized in that at least one clamping element 6 of at least one clamping device 5 engages a section of the blank 1 to form a clamping of the blank 1. The blank 1, as shown in FIG. 1, 2, is clamped in particular clamping situations AS in such a way that the central axis ZA of the blank 1 is at an angle, i.e. is perpendicular in the embodiments shown in the figures, to the vertical axis VA or plane VE. In each clamping situation AS, a specific, in particular exposed and thus mechanically machinable section of the blank 1 is machined. Each clamping situation AS thus typically correlates with a specific machining situation BS of the blank 1.

FIG. 1 shows a first exemplary clamping situation in which a mechanical machining at least in sections, in particular a complete mechanical machining, of the outer circumference of the blank 1, i.e. a lateral surface of the blank 1 that forms the outer circumference, is performed or can be performed (see the curved brackets indicating the machinable region). Such a mechanical machining can mean a mechanical machining of the blank 1 being performed axially with respect to the annular disk-shaped geometry of the blank 1 in relation to the central axis ZA of the blank 1, so that the blank 1 is provided, for example, with a specific outer circumferential contour, in particular one that forms the running surfaces of a wheel to be manufactured, in particular by turning and/or milling. A machining of the blank 1 clamped in the first clamping situation can therefore be used to machine the outer contour or the lateral surface of the component 2 to be manufactured, i.e. in particular the area of the running surfaces of a wheel to be manufactured.

FIG. 1 shows that In the first example of a clamping situation, the blank 1 can be clamped via clamping elements 6 engaging, in particular axially, a section 9 of the inner diameter of the blank, in some cases shoulder-like, protruding, or recessed, for example, in the manner of a borehole 9. The blank 1 can be clamped in the first clamping situation via clamping elements 6 that engage a surface of the blank 1 lying parallel to the disk plane SE, i.e., for example, an upper or lower side of the blank 1. Clamping jaws engaging, for example, the inner diameter or a corresponding surface are contemplated as clamping elements 6 used in the first clamping situation to clamp the blank 1. As can be seen, a plurality of clamping jaws can be used that are distributed, preferably evenly, about the circumference and are arranged such that centering of the blank 1 in the first clamping situation is possible.

In the clamping situation shown in FIG. 1, a mechanical machining at least in sections, in particular a complete mechanical machining, of a surface of the blank 1 lying parallel to the disk plane SE, i.e. for example an upper or lower side of the blank 1, can also be performed. Such a mechanical machining can mean a mechanical machining of the blank 1 performed axially with respect to the (annular) disk-shaped geometry of the blank 1, so that the blank 1 is thereby provided, for example, with axially penetrating through holes or blind holes by drilling. Alternatively or additionally, such mechanical machining can mean mechanical machining of the blank 1 performed radially with respect to the (annular) disk-shaped geometry of the blank 1, so that the blank 1 is provided, for example, with radially extending, in particular annular, recesses. With a corresponding mechanical machining of the inside diameter or in the region of the inside diameter of the blank 1, in some cases a formation of a middle or central recess of the blank 1 can also be understood as being made, for example, by drilling and/or milling, so that a disk-shaped blank 1 is converted into an annular disk-shaped blank 1. A targeted change in the cross-sectional geometry of the blank 1 is possible.

Furthermore, in the clamping situation shown in FIG. 1 a mechanical machining of the outer circumference of the blank 1, i.e. a lateral surface of the blank 1 that forms the outer circumference, can be performed. Such a machining can mean a machining of the blank 1 being performed axially with respect to the (annular) disk-shaped geometry of the blank 1 (in relation to the central axis ZA of the blank 1), so that a the blank 1 is provided, for example, with a specific outer circumferential contour, in particular one that forms the running surfaces of a wheel to be manufactured, in particular by turning and/or milling. Mechanical machining of the blank 1 clamped in the clamping situation shown in FIG. 1 can therefore (also) be used to machine the outer contour or the lateral surface of the disk-shaped or annular disk-shaped component to be produced, i.e. in particular of the region of the running surfaces of a wheel to be produced. A targeted change in the cross-sectional geometry of the blank 1 is also possible here.

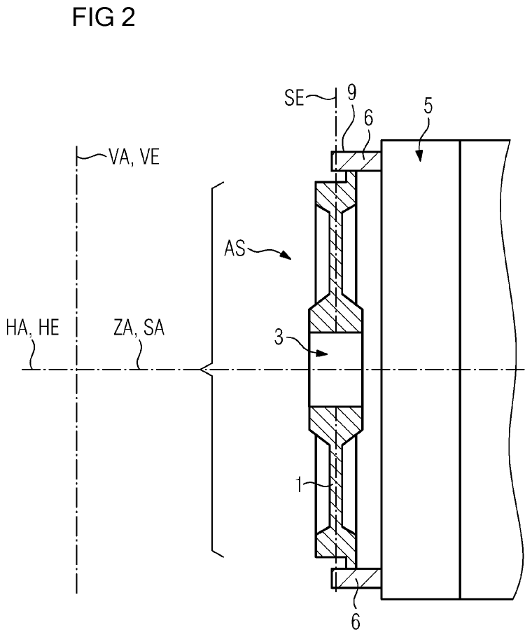

FIG. 2 shows a second exemplary clamping situation of the blank 1, in which a mechanical machining at least in sections, in particular a complete mechanical machining, of a surface of the blank 1 lying parallel to the disk plane SE, i.e., for example, an upper or lower side of the blank 1, is performed or can be performed (see the curved brackets indicating the machinable area). Such a mechanical machining can mean a mechanical machining of the blank 1 performed axially with respect to the annular disk-shaped geometry of the blank 1, so that the blank 1 is provided, in particular by drilling, with through holes that axially penetrate it or blind holes, for example. Alternatively or additionally, such a mechanical machining can mean a mechanical machining of the blank 1 performed radially with respect to the annular disk-shaped geometry of the blank 1, so that the blank 1 is provided, for example, with radially extending, in particular annular, recesses. With a corresponding mechanical machining of the inside diameter or in the region of the inside diameter of the blank 1, in some cases a formation of a middle or central recess of the blank 1 can also be understood as being made for a disk-shaped blank 1, for example, by drilling and/or milling, so that a disk-shaped blank 1 is converted into an annular disk-shaped blank 1.

FIG. 2 shows that the blank 1 can be clamped in the second exemplary clamping situation via clamping elements 6 engaging the outer circumference of the blank 1 or a lateral surface of the blank 1 that forms the outer circumference. Clamping jaws engaging, for example, the outer circumference or the lateral surface that forms the outer circumference are contemplated as the clamping elements 6 used to clamp the blank 1 in the second exemplary clamping situation. In particular, a plurality of clamping jaws arranged distributed, preferably evenly, about the outer circumference can be used. The clamping jaws can be arranged in such a way that it is possible to center the blank 1 in the second clamping situation.

FIG. 1, 2 thus show that a blank 1 can be clamped and mechanically machined in a plurality of different clamping situations AS. Each clamping situation AS is correlated with a specific machining situation. In each clamping or machining situation, the sections of the clamped blank 1 that are exposed therein can be machined.

FIG. 3 shows a basic illustration of a machining center 4 which can be used or is used for carrying out the method according to an embodiment. The machining center 4 comprises a clamping device 5, which is configured to clamp a mechanically machined blank 1 in a clamping situation AS in which the central axis ZA of the blank is at an angle to a vertical axis VA or plane VE, as well as at least one mechanical machining device 8, which comprises at least one mechanical machining tool 7, i.e., for example, a drilling and/or turning and/or milling tool, i.e., for example, a drilling and/or turning and/or milling device which is configured to mechanically machine a blank 1, at least in sections, that is clamped in the clamping situation AS. Also shown is an optional blank storage 10, via which blanks 1 to be machined mechanically can be made available by means of the machining center 4. The blanks 1 can be drawn from the blank storage 10 via a handling device 11 designed as a single or multi-axis handling robot and fed to a machining room 12 of the machining center 4, clamped there accordingly and mechanically machined.

It can be seen from FIG. 3 that the vertical axis VA or plane VE with respect to which blanks 1 can be clamped or have been clamped at an angle according to the method is typically oriented perpendicular to a (horizontal) machining or machine axis MA of the machining center 4.

With reference to FIG. 3, it can also be explained that, in the clamping situation shown there or a corresponding clamping situation, both a mechanical machining of a surface of the blank 1 lying parallel to a central plane, i.e. for an (annular) disk-shaped blank 1 parallel to a disk plane, i.e. an upper or lower side of the blank 1, and a mechanical machining of the outer circumference of the blank 1 can be performed. Sections of the blank 1 that cannot be machined or can be machined in the clamping situation can be machined mechanically in one of the same clamping situation. For this purpose, a rotary or turning movement of the blank 1 mechanically machined in sections is required. The blank 1 mechanically machined in sections can be moved, rotated or turned out of the clamping situation after mechanical machining in the clamping situation—this is in particular a 180° rotation or turn—and moved back into the (same) clamping situation and clamped again in order to then machine the remaining not yet mechanically machined sections. The blank 1 can then be clamped on opposite section of the blank 1; in the renewed clamping of the blank in the clamping situation in comparison to the first or previous clamping, the clamping elements 6 engage opposite section of the blank 1 in the clamping situation.

For this purpose, a suitable handling of the blank 1 mechanically machined in sections may be required, and this can be implemented, for example, via a handling device 11, i.e. in particular a robot device. The handling device 11 can therefore be configured to remove a blank 1 which has already been mechanically machined in sections from the clamping situation, to rotate or turn it, and to transfer it back into the (same) clamping situation.

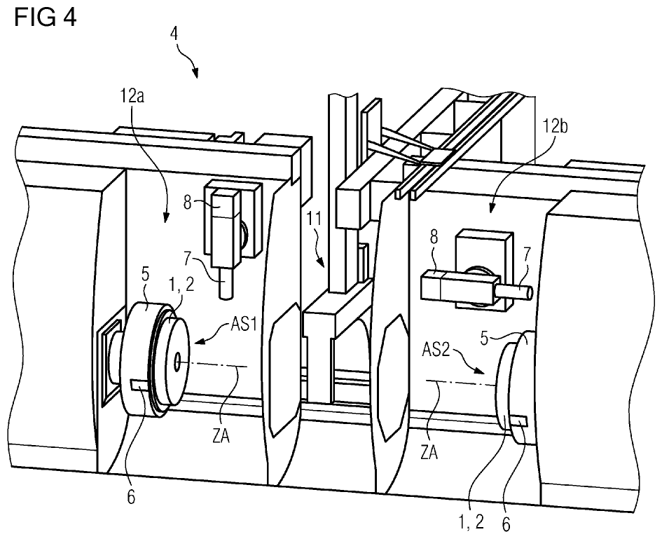

FIG. 4 shows a basic illustration of a machining center 4 which can be used or is used for carrying out the method according to a further embodiment. In contrast to the embodiment according to FIG. 3, the machining center 4 shown in FIG. 4 has a plurality of machining spaces 12a, 12b, in each of which a mechanical machining of a blank 1 is possible. It can be seen that each machining space 12a, 12b therefore has its own mechanical machining device 8.

In reference to the embodiment shown in FIG. 4, it can be explained that a blank 1 from a first clamping situation AS or first machining situation, in which the central axis ZA of the blank 1 is at an angle to the vertical axis VA or plane VE, can be transferred into at least one further clamping situation AS2 or further machining situation, in which the central axis ZA of the blank 1 is at an angle to the vertical axis VA or plane VE. This opens up the possibility of providing a plurality of blanks 1 and of machining them at least in part simultaneously.

In reference to the machining center 4 shown in FIG. 4 comprising two separate machining rooms 12a, 12b, it is possible, for example, that a first blank 1 to be mechanically machined is initially clamped in a first clamping situation AS1 in which the central axis ZA of the first blank 1 is at an angle to the vertical axis VA or plane VE, and is mechanically machined at least in sections in a first mechanical machining step in the first clamping situation AS1 (see. FIG. 4). After completion of the first mechanical machining step, the first blank 1, which has already been machined in sections, can be transferred into a second clamping situation AS2 (different from the first clamping situation AS1) in which the central axis ZA of the first blank 1 is again at an angle to the vertical axis VA or plane V2, clamped therein and in a second mechanical machining step can be transferred mechanically machined at least in sections. A second blank 1 to be mechanically machined in the first clamping situation AS1 can be clamped during or after clamping of the first blank 2 in the second clamping situation AS2 and can be mechanically machined at least in sections in a first mechanical machining step in the first clamping situation. After completion of the first mechanical machining step, the second blank 1, which has already been machined in sections, can be transferred to the second clamping situation AS2, clamped therein and mechanically machined at least in sections in a second mechanical machining step. This typically occurs only when the first blank 1 has left the second clamping situation AS2, i.e. the second mechanical machining step of the first blank 1 in the second clamping situation AS2 has been completed. Mechanical machining of a plurality of blanks 1 can therefore be performed in succession in time in a plurality of clamping situations AS1, AS2, i.e. machining of a plurality of blanks 1 in a plurality of clamping situations AS1, AS2 one after the other. The second mechanical machining step of the first blank 1 can be performed at least in part simultaneously with the first mechanical machining step of the second blank 1 (and vice versa).

It is also possible that a first blank 1 to be mechanically machined is initially clamped in a first clamping situation AS1, in which the central axis ZA of the first blank 1 is at an angle to the vertical axis VA or plane VE, and is mechanically machined at least in sections in a first mechanical machining step in the first clamping situation AS1. After completion of the first mechanical machining step, the blank 1, which has already been mechanically machined in sections, can be transferred into a second clamping situation AS2, in which the central axis ZA of the first blank 1 is again at an angle to the vertical axis VA or plane VE, clamped therein and in a second mechanical machining step can be mechanically machined at least in sections. A second blank 1 to be mechanically machined can initially be clamped in the second clamping situation AS2 and in a first mechanical machining step be mechanically machined at least in sections in the second clamping situation AS2. After completion of the first mechanical machining step of the first blank 1 in the first clamping situation and after completion of the first mechanical machining step of the second blank 1 in the second clamping situation AS2, the first blank 1 can be transferred to the second clamping situation AS2, clamped therein and be mechanically machined at least in sections in a second mechanical machining step, and after completion of the first mechanical machining step of the second blank 1 in the second clamping situation AS2 and the first mechanical machining step of the first blank 1 in the first clamping situation AS1, the second blank 1 can be transferred to the first clamping situation AS1, clamped therein and be mechanically machined at least in sections in a second mechanical machining step. A simultaneous mechanical machining of the blanks 1 can therefore be performed in respective clamping situations AS1, AS2. The blanks 1 machined at least in sections in the respective first machining steps can then swap their respective first clamping situations AS1, AS2 and, after clamping in respective second clamping situations AS1, AS2, can be subjected to respective second mechanical machining steps. The first mechanical machining step of the first blank 1 can therefore be performed at the same time as the first mechanical machining step of the second blank 1. The second mechanical machining step of the first blank 1 can therefore also be performed at the same time as the second mechanical machining step of the second blank 1.

From the above it follows that each clamping situation AS1, AS2 is assigned a machining device 8 which is configured to carry out a mechanical machining of a clamped blank 1 to be carried out in the respective clamping situation AS1, AS2 or the machining situation correlated therewith. For this purpose, the machining device 8 assigned to the respective clamping situation AS1, AS2 can be movably supported in at least a degree of freedom of movement relative to the blank 1 clamped in the respective clamping situation AS1, AS2. Alternatively or additionally, however, it is also conceivable in principle that the blank 1 clamped in the respective clamping situation AS1, AS2 in at least a degree of freedom of movement, i.e., for example, a degree of freedom of movement along a translation axis and/or about an axis of rotation, is movably mounted relative to the mechanical machining device 8 associated with the respective clamping situation AS1, AS2.

The transfer of a blank 1, in some cases already mechanically machined at least in sections, from a first clamping situation AS1 to the second clamping situation AS2 (or vice versa) can be carried out using a handling device 11 that already includes one or more handling elements in connection with the embodiment shown in FIG. 3, i.e. for example a handling robot. The handling device 11 is therefore configured to transfer a blank 1, in some cases already mechanically machined at least in sections, from the first clamping situation AS2 into the second clamping situation AS2 (or vice versa).

Although not shown in the figures, a clamping of the blank 1 in a tilted or inclined orientation relative to the vertical axis VA or plane VE would also be conceivable; the central axis ZA of the blank 1, which is inclined here with respect to the vertical axis VA or plane VE, would be oriented at an angle α between 1 and 179°, in particular between 15 and 175°, preferably at an angle α between 30 and 150°.

1. A method for producing at least one disk-shaped or annular disk-shaped component, in particular a disk-shaped or annular disk-shaped wheel, comprising:
providing at least one blank which has a central axis and is to be machined mechanically, in particular by cutting;
arranging or clamping the blank in at least one clamping situation in which the central axis of the blank is at an angle to a vertical axis;
mechanically machining the clamped blank, in particular by cutting, to produce the disk-shaped or annular disk-shaped component.

2. The method according to claim 1, characterized in that the blank has a disk-shaped or annular disk-shaped geometry.

3. The method according to claim 1, characterized in that the blank is clamped in such a way that the central axis of the blank is oriented at an angle between 1 and 179°, in particular between 15 and 175°, and preferably at an angle between 30 and 150° relative to the vertical axis.

4. The method according to claim 1, characterized in that the blank is clamped in such a way that the central axis of the blank is oriented at an angle of 90° relative to the vertical axis.

5. The method according to claim 1, characterized in that the blank is clamped in a clamping situation in which a mechanical machining is performed at least in sections, in particular a complete mechanical machining, of a surface of the blank parallel to a central plane of the blank, and a mechanical machining is performed at least in sections, in particular a complete mechanical machining, of the outer circumference of the blank.

6. The method according to claim 5, characterized in that the blank is clamped in the clamping situation via clamping elements engaging a portion of the inside diameter of the blank, in particular an axially protruding or recessed portion.

7. The method according to claim 1, characterized in that the blank is clamped in a plurality of different clamping situations.

8. The method according to claim 7, characterized in that the blank is clamped in a first clamping situation in which a mechanical machining is performed at least in sections, in particular a complete mechanical machining, of a surface of the blank lying parallel to a central plane of the blank.

9. The method according to claim 8, characterized in that the blank in the first clamping situation is clamped via clamping elements engaging the outer circumference of the blank.

10. The method according to claim 7, characterized in that the blank is clamped in a second clamping situation in which a mechanical machining is performed at least in sections, in particular a complete mechanical machining, of the outer circumference of the blank.

11. The method according to claim 10, characterized in that the blank is clamped in the second clamping situation via clamping elements engaging a portion of the inside diameter of the blank, in particular an axially protruding or recessed portion.

12. The method according to claim 1, characterized in that the blank from a first clamping situation, in which the central axis of the blank is at an angle to the vertical axis, is transferred into at least one further clamping situation, in which the central axis of the blank is at an angle to the vertical axis.

13. The method according to claim 1, characterized in that a plurality of blanks to be mechanically machined, in particular by cutting, are provided which have a central axis, wherein
a first blank initially is clamped in a first clamping situation, in which the central axis of the first blank is at an angle to the vertical axis, and in a first mechanical machining step is mechanically machined at least in sections in the first clamping situation and after completion of the first mechanical machining step is transferred into a second clamping situation, in which the central axis of the first blank is at an angle to the vertical axis, is clamped therein and in a second mechanical machining step is mechanically machined at least in sections, and
during or after clamping of the first blank in the second clamping situation, a further blank is clamped in the first clamping situation and in a first mechanical machining step is mechanically machined at least in sections in the first clamping situation and after completion of the first mechanical machining step is transferred into the second or a further clamping situation, in which the central axis of the further blank is at an angle to the vertical axis, is clamped therein, and in a second mechanical machining step is mechanically machined at least in sections.

14. The method according to claim 1, characterized in that a plurality of blanks to be mechanically machined, in particular by cutting, are provided which have a central axis, wherein
a first blank initially is clamped in a first clamping situation, in which the central axis of the first blank is at an angle to the vertical axis, and in a first mechanical machining step is mechanically machined at least in sections in the first clamping situation and after completion of the first mechanical machining step is transferred into a second clamping situation, in which the central axis of the first blank is at an angle to the vertical axis, is clamped therein and in a second mechanical machining step is mechanically machined at least in sections, and
a further blank is initially clamped in a second clamping situation, in which the central axis of the further blank is at an angle to the vertical axis, and is mechanically machined at least in sections in a first mechanical machining step in the second clamping situation, wherein
after completion of the first mechanical machining step of the first blank in the first clamping situation and of the first mechanical machining step of the further blank in the second clamping situation, the first blank is transferred into the second clamping situation, clamped therein and is mechanically machined at least in sections in a second mechanical machining step, and, after completion of the first mechanical machining step of the further blank in the second clamping situation and of the first mechanical machining step of the first blank in the first clamping situation, the further blank is transferred into the first clamping situation, clamped therein and is mechanically machined at least in sections in a second mechanical machining step.

15. The method according to claim 1, characterized in that a wheel for a rail vehicle, in particular a train wheel, is produced.

16. A machining center for the mechanical machining, in particular cutting, of a blank to be machined, in particular cut, for the production of a disk-shaped or annular disk-shaped component, in particular according to the method of claim 1, characterized by:
at least one clamping device, which is configured to clamp a blank to be mechanically machined in at least one clamping situation, in which the central axis of the blank to be mechanically machined, in particular cut, is at an angle to a vertical axis,
at least one mechanical machining device which is configured to mechanically machine at least in sections a blank clamped in the clamping situation.
